(19) United States
(12) Patent Application Publication
(10) Pub. No.: US 2011/0048357 A1
(43) Pub. Date: Mar. 3, 2011

(54) Parallel Starter System

(76) Inventors: Hartmut Wanner, Herrenberg-Oberjesingen (DE); Thomas Majer, Barcelona (ES)

(21) Appl. No.: 12/735,246

(22) PCT Filed: Dec. 17, 2008
(86) PCT No.: PCT/EP2008/067753

§ 371 Date: Nov. 17, 2010

(30) Foreign Application Priority Data
Jan. 15, 2008 (DE) 102008004381.8

(51) Int. Cl. F02N 11/00

(52) U.S. Cl. 123/179.25

(57) ABSTRACT

A parallel starter system for starting an internal combustion engine has at least two parallel-connected starters and a thermal switch associated with each of the starters, which thermal switch interrupts operation of the respective starter in the event of a response. The thermal switches are connected in series so that in the event of tripping of one of these thermal switches, the operation of all starters is interrupted.

### BACKGROUND OF THE INVENTION

1. Field of the Invention

The invention relates to a parallel starter system for starting an internal combustion engine having at least two starters connected in parallel. Such parallel starter systems are used with engines having a larger displacement, in order to be able to supply the required high starter power.

2. Description of Related Art

Published German patent application document DE 39 22 492 A1 describes a starter protection circuit for starting an internal combustion engine of a motor vehicle. A thermal switch, which operates a starter operation-interrupting relay in the event of a response, is assigned to the starter. After resuming the cold-switching state of the thermal switch, renewed starter operation may be achieved via a relay operation button.

Published German patent application document DE 10 2005 006 248 A1 describes a parallel starter system having a low wiring complexity. It includes multiple starters connected in parallel, each having a starter motor and an engagement relay. This parallel starter system may be implemented in a particularly simple and inexpensive manner if at least one of the switches includes a power relay, which switches the main current path to the respective starter motor, and the engagement relay, the power relay and the starter motor are implemented as a structural unit.

### BRIEF SUMMARY OF THE INVENTION

A parallel starter system of the present invention has the advantage over the related art that terminal 50 (shown in FIG. 1) of both or all starters of the parallel starter system is reliably isolated in the event the thermal switch of one of the starters is tripped. This increases the reliability of a parallel starter system in the event of a thermal overload of one of the starters.

The design and internal wiring of the connecting line ensures that both or all starters may have the same design. The wiring is determined only via the wiring in the connecting line. Each starter receives a plug contact having 8 pins.

### BRIEF DESCRIPTION OF THE DRAWING

FIG. 1 shows a wiring diagram of a parallel starter system according to one exemplary embodiment of the present invention.

### DETAILED DESCRIPTION OF THE INVENTION

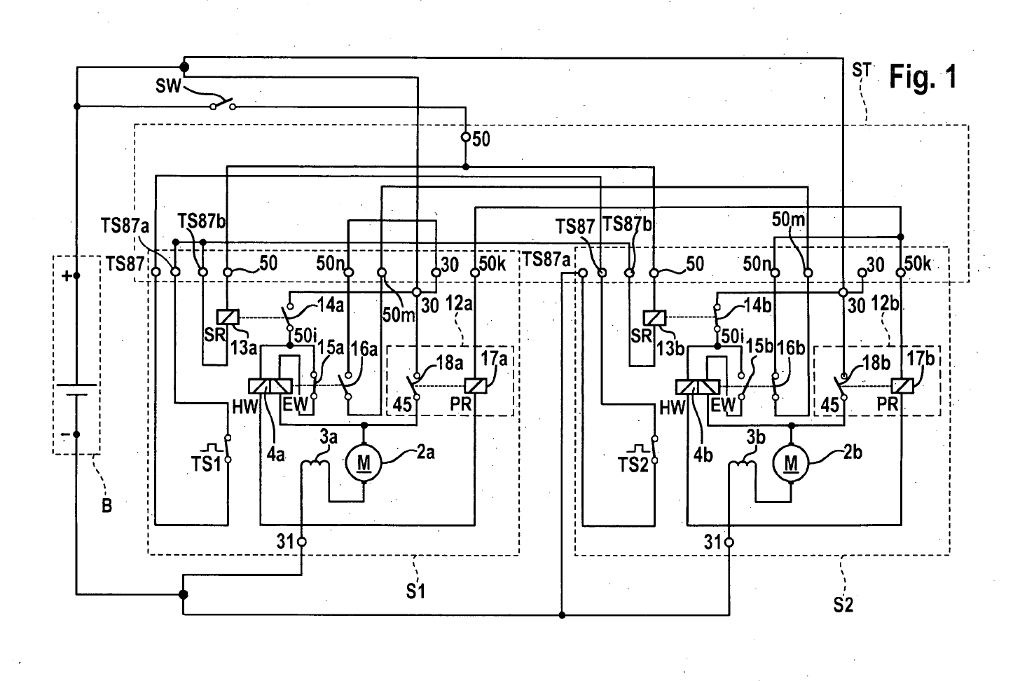

FIG. 1 shows a parallel starter system having two starters S1 and S2 connected in parallel. Starter S1 includes a starter relay 13a, an engagement relay 4a having a hold-in winding HW and a pull-in winding EW, a power relay 17a, a starter motor 2a, a winding 3a, a thermal switch TS1 and switches 14a, 15a, 16a and 18a. Starter S2 includes a starter relay 13b, an engagement relay 4b having a hold-in winding HW and a pull-in winding EW, a power relay 17b, a starter motor 2b, a winding 3b, a thermal switch TS2 and switches 14b, 15b, 16b and 18b.

The main current of starter motor 2a of first starter S1 is switched by power relay 17a. The main current of starter motor 2b of second starter S2 is switched by power relay 17b. Engagement relay 4a serves to engage a pinion (not shown) into the appropriate gear rim of starter S1 and to provide the current for turning over starter S1. Engagement relay 4b engages a pinion (not shown) in the appropriate gear rim of starter S2 and provides the current for turning over starter S2.

In addition, the parallel starter system shown in FIG. 1 contains a system cable implemented in the form of a plug ST within which the connecting lines run between two starters S1 and S2. Each of the starters has a plug contact, each having 8 pins via which the respective starter S1 and S2 is connected to the plug, i.e., the system cable. The aforementioned 8 pins are labeled as TS87, TS87a, TS87b, 50, 50n, 50m, 30 and 50k.

Plug ST has a terminal in its upper area corresponding to terminal 50. This is connected by a switch SW to positive pole+of a battery B. In addition, a line leads from the positive pole of battery B through plug ST to terminal 30 of first starter S1. A line also leads from the positive pole of battery B through plug ST to terminal 30 of second starter S1. A connecting line leads from terminal 50 in the upper area of plug ST to pin 50 of starter S1. Another connecting line leads from terminal 50 in the upper area of plug ST to pin 50 of starter S2.

The negative pole of battery B is connected to pin 31 of first starter S1, to pin 31 of second starter S2, and to thermal switch TS2 of starter S2 via pin TS87 of starter S2.

Pin 31 of first starter S1 is connected to starter motor 2a of first starter S1 via winding 3a. Pin 31 of second starter S2 is connected to starter motor 2b of second starter S2 via winding 3b.

Thermal switches TS1 of first starter S1 and TS2 of second starter S2 are connected in series. Terminal 50 in the upper area of plug ST is thus connected to thermal switch TS2 of second starter S2 via pin 50 of first starter S1, starter relay 13a of first starter S1, pin TS87b of first starter S1, pin TS87a of first starter S1, thermal switch TS1 of first starter S1, pin TS87 of first starter S1, and pin TS87 of second starter S2. The other terminal of thermal switch TS2 is connected to the negative pole—of battery B via pin TS87a of second starter S2.

In a starting operation, initiated by closing of switch SW, starter relays 13a and 13b, which are connected in parallel, start at the same time and close corresponding switches 14a and 14b. Therefore, within the particular starter, the connection between pin 30 and point 50i is closed, and the control terminals of engagement relays 4a and 4b receive power.

The pinion of starters S1 and S2 is moved forward into the gear rim by both engagement relays 4a and 4b being pulled in. A limited current then flows into starters S1 and S2 via the pull-in winding of engagement relays 4a and 4b, thus causing the pinion to turn slightly. This slight turning simplifies the engagement procedure because tooth-on-tooth positions of the pinion on the gear rim may be eliminated in this way.

Switch 16a of engagement relay 4a and switch 16b of engagement relay 4b are able to close only when both pinions have been engaged. After both switches have closed, power relays 17a and 17b receive power, and therefore switch 18a of relay 17a and switch 18b of relay 17b are closed. After both switches are closed, starters S1 and S2 receive power directly and are able to start the engine.

The advantage of this circuit is that starting is possible only when both pinions have been engaged. This ensures that a uniform load on the starters is achieved.

If there is a thermal overload on one of the starters, then the particular thermal switch is tripped and interrupts operation of the particular starter. Since the two thermal switches are connected in series, tripping of one of the thermal switches also results in the current flow through the other thermal switch being interrupted. Therefore, operation of both starters is interrupted because they are no longer triggered via pin 50. This has the advantage that in the event of a thermal overload on one of the starters, operation of not only the overloaded starter but also the other starter of the parallel starter system is interrupted, thus preventing a thermal overload of the additional starter(s) of the parallel starter systems.

In contrast, in known parallel starter systems, the starter relay of the particular starter is interrupted by the tripping of a thermal switch, resulting in a drop in both power relays. However, this causes only a drop in the engagement relay of the particular starter. The second engagement relay remains pulled in, which may result in a thermal overload on the relay and additional subsequent damages. These disadvantages do not occur with a parallel starter system according to the present invention.

1.-6. (canceled)

7. A parallel starter system for starting an internal combustion engine, comprising:
at least a first starter and a second starter connected to each other in parallel;
at least a first thermal switch and a second thermal switch assigned to the first starter and the second starter, respectively, wherein each thermal switch is configured to interrupt operation of the respective assigned starter in the event of a response, and wherein the thermal switches are connected in series to interrupt operation of the first and second starters in the event of tripping of one of the first and second thermal switches.

8. The parallel starter system as recited in claim 7, further comprising:
a battery having a positive pole connected by a battery switch and a starter relay of the first starter to the thermal switch of the first starter.

9. The parallel starter system as recited in claim 8, wherein the thermal switch of the first starter is connected to the thermal switch of the second starter by an output of the first starter and an input of the second starter.

10. The parallel starter system as recited in claim 9, wherein the thermal switch of the second starter is connected to the negative pole of the battery by an output of the second starter.

11. The parallel starter system as recited in claim 9, wherein the first and second starters are interconnected by a plug.

12. The parallel starter system as recited in claim 11, wherein each of the first and second starters has a plug contact having eight pins for connection to the plug (ST).
